(19) United States
(12) Patent Application Publication
(10) Pub. No.: US 2019/0080263 A1
(43) Pub. Date: Mar. 14, 2019

(54) SYSTEM FOR EVENT SELECTION AND MATCHING

(71) Applicants: KENNETH THOMAS MADSON, NASHVILLE, TN (US); ALEX AARON LIPSITZ, NASHVILLE, TN (US)

(72) Inventors: KENNETH THOMAS MADSON, NASHVILLE, TN (US); ALEX AARON LIPSITZ, NASHVILLE, TN (US)

(21) Appl. No.: 16/012,655

(22) Filed: Jun. 19, 2018

Related U.S. Application Data
(60) Provisional application No. 62/521,579, filed on Jun. 19, 2017.

(51) Int. Cl. G06Q 10/02; G06Q 50/00; H04L 12/58; G06F 17/30

(52) U.S. Cl. CPC G06Q 10/02; G06F 17/3056; H04L 51/046; G06Q 50/01

(57) ABSTRACT

A system for multiple users to identify one or more events, obtain tickets to said events, and interact and select matches with other users for said events. The system comprises one or more computer servers operating on a network, such as, but not limited to, the Internet, and in electronic communication with multiple users through a client program or application running on various user computing devices, including, but not limited to, a personal computer, laptop, smart phone, tablet, or mobile computing device. The client applications display the data and handle user interactions. The server or servers are responsible for processing all of the data, finding potential matches, and communicating with third party servers or services (such, as but not limited to, ticket vendors, and credit card or payment processors).

This application claims benefit of and priority to U.S. Provisional Application No. 62/521,579, filed Jun. 19, 2017. The specification, drawings and complete disclosure of U.S. Provisional Application No. 62/521,579 are incorporated herein by specific reference in their entireties for all purposes.

### FIELD OF INVENTION

This invention relates to a system and related methods for users to interact, select matches, and obtain tickets for specific events.

### SUMMARY OF INVENTION

This invention relates to a computer-based system and application for multiple users to identify one or more events, obtain tickets to said events, and interact and select matches with other users for said events. The system comprises one or more computer servers operating on a network, such as, but not limited to, the Internet, and in electronic communication with multiple users through a client program or application running on various user computing devices, including, but not limited to, a personal computer, laptop, smart phone, tablet, or mobile computing device. The client applications display the data and handle user interactions. The server or servers are responsible for processing all of the data, finding potential matches, and communicating with third party servers or services (such, as but not limited to, ticket vendors, and credit card or payment processors).

Client applications are designed for and run on the appropriate operating system for user mobile devices (e.g., iOS or Android). In one embodiment, the client applications are powered by React Native, which allows for rapid development of the front end user interface, as well as for easily sharing code among client applications. The client applications are responsible for authorizing and authenticating users as well as communicating with the server API (i.e., RESTful API). In this embodiment, the server is a node server application using the express framework to create the RESTful API. This API acts as the “middle man” between the client application, the database (described below), and any third party servers or service with which the system needs to integrate. For example, the server in this embodiment communicates with services such as Ticketmaster's API to gather data on events (for display to users) and to purchase tickets for an event.

One or more databases also are in electronic communication with the main system server or servers. The database contains various data about member users, as detailed below, that is used to identify possible matches among users and complete ticket purchases. The server processes data from incoming requests, and queries the database for possible matches or makes calls to a third party service to find the needed data. The server then combines this data into an easily consumable JSON package that is sent back to the user's client application.

### BRIEF DESCRIPTION OF THE DRAWINGS

FIG. 1 shows a view of a system in accordance with an embodiment of the present invention.

FIGS. 2-7 show exemplary views of signup and login pages for a user application in accordance with an embodiment of the present invention.

FIGS. 8-9 show examples of settings screens.

FIGS. 10-11 show examples of personal profile screens.

FIG. 12 shows an example of an all events listing screen.

FIG. 13 shows an example of an events detail view screen.

FIG. 14 shows another example of an all events listing screen.

FIGS. 15-17 show examples of events detail view screens.

FIG. 18 shows an example of match confirmation screen.

FIG. 19 shows an example of an introductory match view screen.

FIG. 20 shows an example of an alert screen.

FIGS. 21-24 show examples of chat list views and screens.

FIG. 25 shows another example of an events detail view screen.

FIG. 26 shows another example of an introductory match view screen.

FIG. 27 shows an example of a block screen.

FIGS. 28-34 show examples of administrative portal interface screens.

### DETAILED DESCRIPTION OF EXEMPLARY EMBODIMENTS

In various exemplary embodiments, the present invention comprises a computer-based system and application for multiple users to identify one or more events, obtain tickets to said events, and interact and select matches with other users for said events. The system comprises one or more computer servers operating on a network, such as, but not limited to, the Internet, and in electronic communication with multiple users through a client program or application running on various user computing devices, including, but not limited to, a personal computer, laptop, smart phone, tablet, or mobile computing device. The client applications display the data and handle user interactions. The server or servers are responsible for processing all of the data, finding potential matches, and communicating with third party servers or services (such, as but not limited to, ticket vendors, and credit card or payment processors).

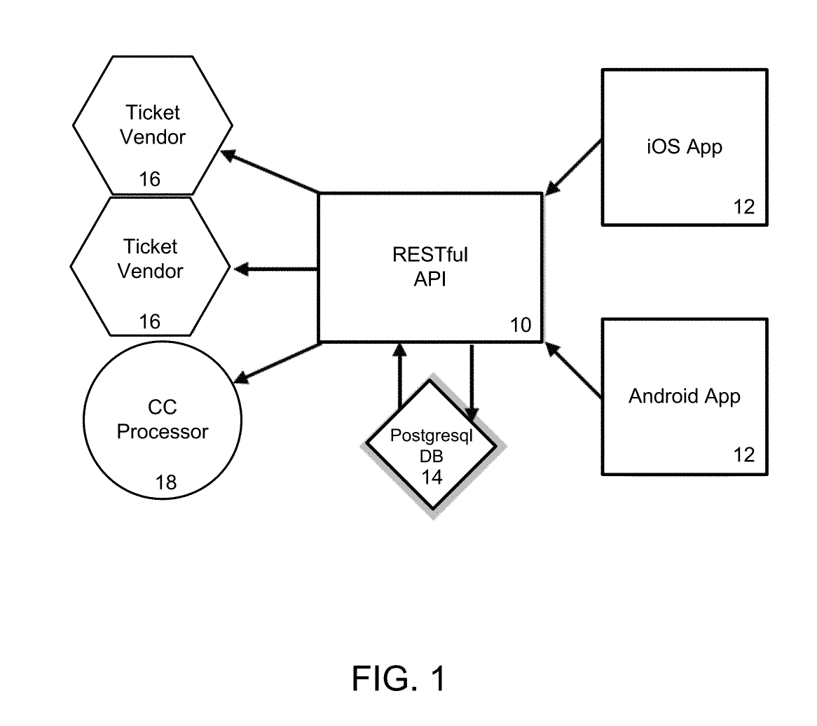

FIG. 1 shows one embodiment of the system. Client applications are designed for and run on the appropriate operating system for user mobile devices (i.e., iOS or Android). In the embodiment shown, the client applications are powered by React Native, which allows for rapid development of the front end user interface, as well as for easily sharing code among client applications. The client applications are responsible for authorizing and authenticating users as well as communicating with the server API (i.e., RESTful API).

In this embodiment, the server 10 is a node server application using the express framework to create the RESTful API. This API acts as the “middle man” between the client application(s) 12, the database 14 (described below), and any third party servers or service with which the system needs to integrate. For example, the server 10 in this embodiment communicates with services such as a ticket vendor's 16 (e.g., Ticketmaster's) API to gather data on events (for display to users) and to purchase tickets using a credit card processor 18 for an event.

One or more databases also are in electronic communication with the main system server or servers. In the embodiment shown, the database is a PostgreSQL database. The database contains various data about member users, as detailed below, that is used to identify possible matches among users and complete ticket purchases. The server processes data from incoming requests, and queries the database for possible matches or makes calls to a third party service to find the needed data. The server then combines this data into an easily consumable JSON package that is sent back to the user's client application.

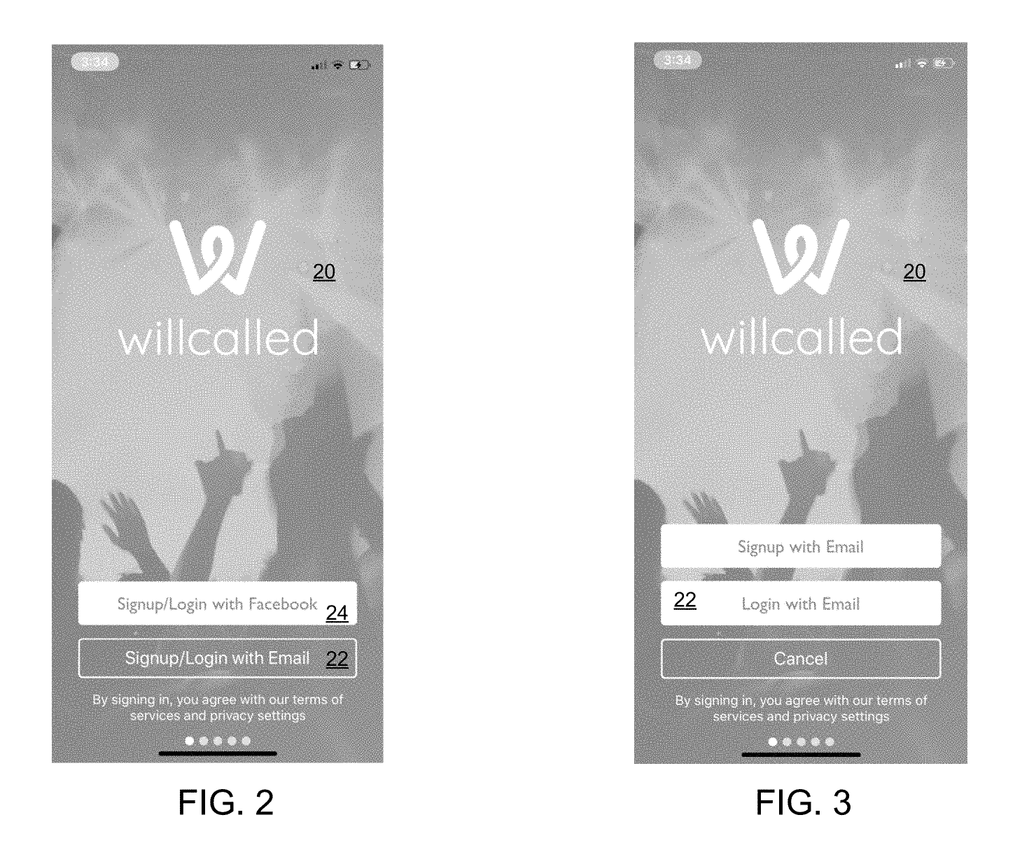

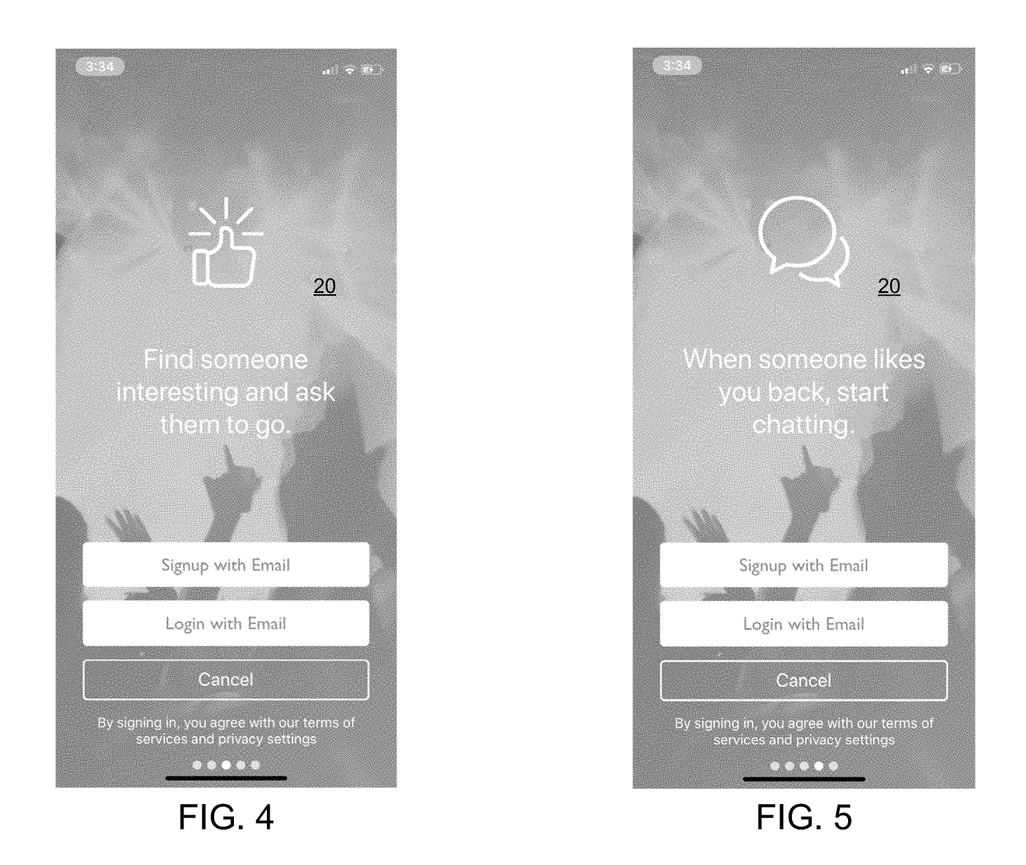

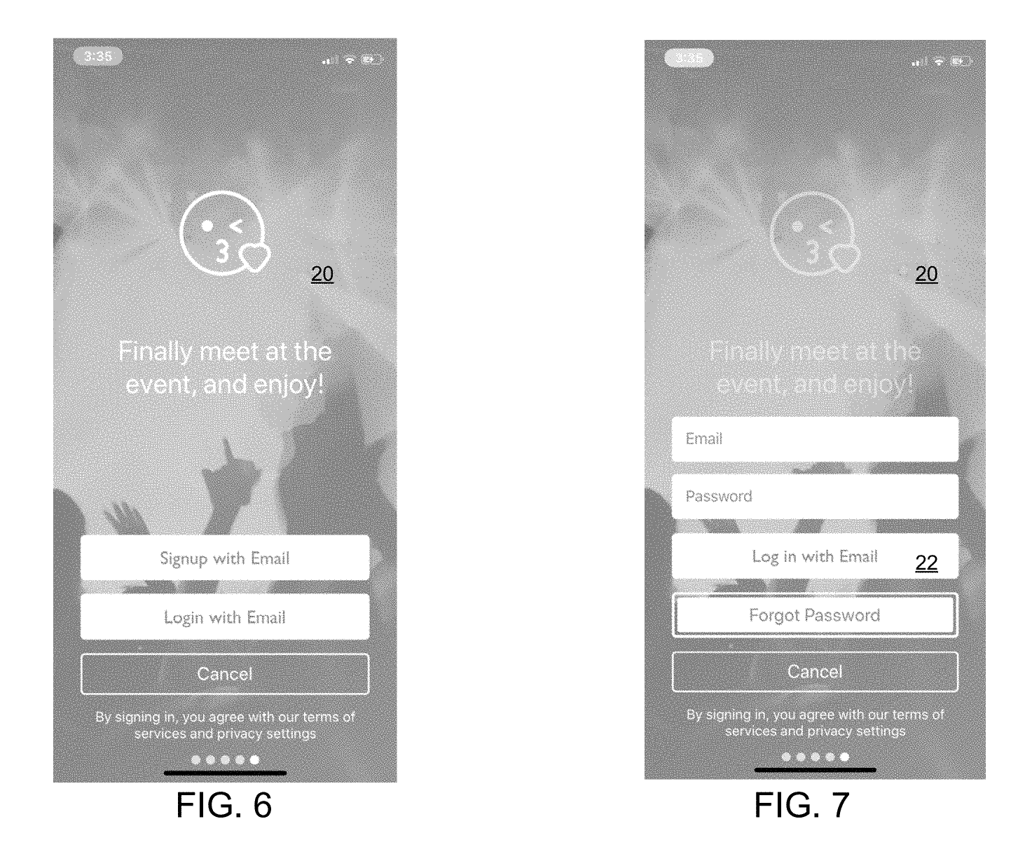

FIGS. 2-7 shows example of signup/login pages 20 for a user application. The login page may be used both as an onboarding screen for new users, as well as a “gatekeeper” view prompting the user for authentication information, and allowing access only after authentication. Users can sign up or login through email 22 or various social media platforms, such as Facebook 24.

Further, user authentication and authentication may be handled in conjunction with a specific social media program. In the embodiment shown, the application uses Facebook's open developer API. Each client application presents a view of the Facebook authentication portal to the user. The user then enters his or her Facebook login credentials into the portal, and the SDK then validates and authenticates the user. Upon authentication, a token is passed to the client application, which is stored for use in future API calls to the system server.

In several embodiments, the various pages of the application use an onboarding slider function for user input, where the slider registers a “pan gesture recognizer” that can detect which direction a user is intending to move on a touchscreen display. The application then advances the slider to the right or left, and reveals more information about the application, based upon the context.

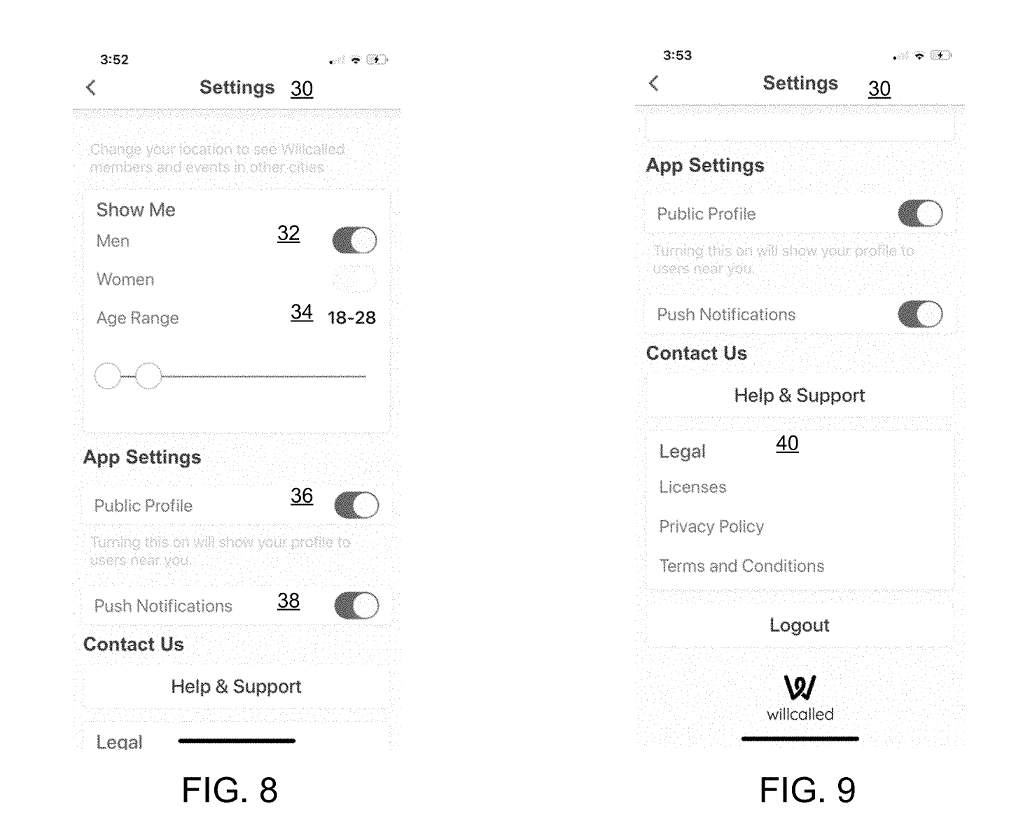

User preferences are managed using the Settings 30 function, examples of which are seen in FIGS. 8-9. The user determines how he or she interacts with the application. Parameters can be changed using standard form controls. Preferences include, but are not limited to, gender 32, age ranges 34, profile availability 36, and authorization for push notifications 38. The settings pages also provide links 40 for contact information, privacy policies, terms and conditions of use, and similar documents. Settings are stored locally on the user device using device specific storage APIs. Data is retrieved using these APIS, and used to modify the parameters fed into the matching algorithm.

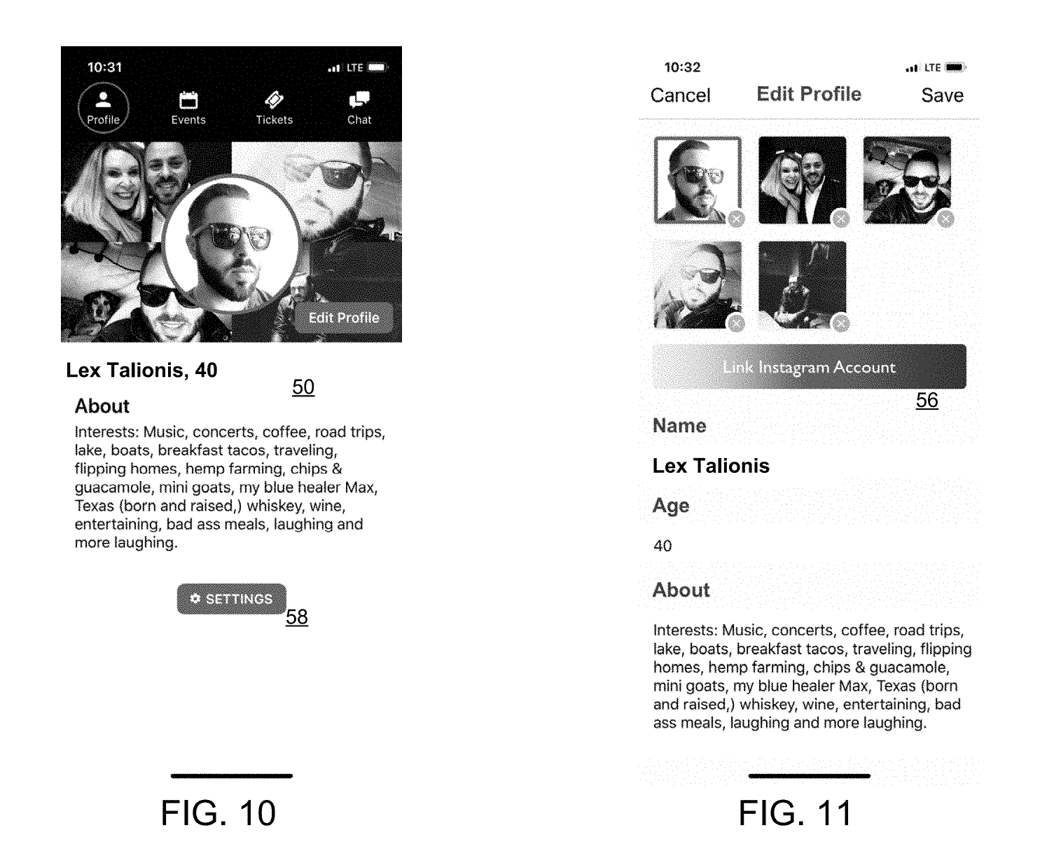

As seen in FIG. 10-11, the user also can add or edit their personal profile information 50 that will be visible to other users, including links to social media accounts 56. The profile view provides the user an entry point 58 to modify settings or customize their experience in the system, including how their profile or information will be presented to potential matches. The user uses this view to upload photographs or images, or alter their metadata.

In several embodiments, the initial set of user data and photos may be derived or obtained from their Facebook profile (access to their Facebook profile is given by the user when they login and register with the system). Changes to the “about” and other sections can be made and stored through this view, using standard data entry and storage techniques and text entry mechanisms. Photos may be uploaded by a tool encoding the image and breaking up the data into chunks that are sent to the system server for storage and later retrieval. The user can upload new photos and delete or replace existing photos.

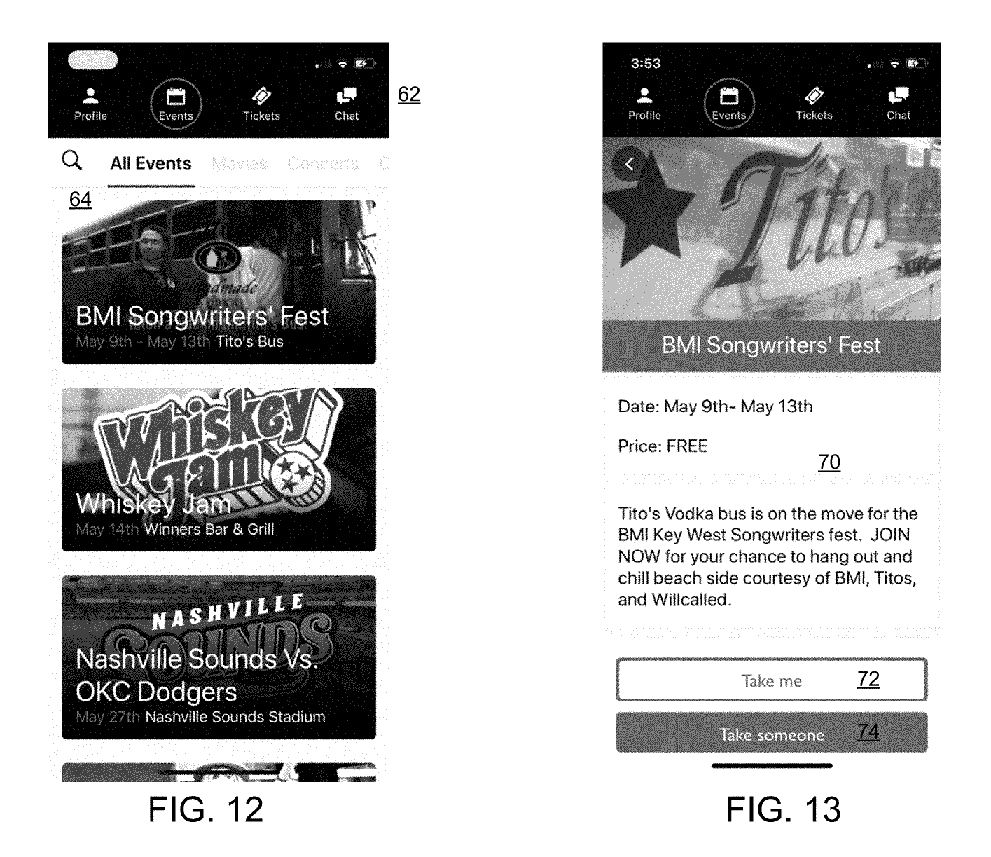

After the user has been authenticated, the user is presented with a “home” view, an example of which is shown in FIG. 12. The home view provides a central place for the user to use to navigate to other of the application, and the user can quickly return to this view from anywhere in the application.

In the embodiment shown, the home view comprises a “tab bar” 62 along the top, above a general purpose view section (which in this case defaults to an “All Events” listing 64). The tab bar displays a predetermined number of user-selectable buttons or icons, with each button or icon corresponding to an area of the application areas (e.g., Profile, Events, Tickets, Chat). When the user taps or touches a button or icon in the tab bar, the selection is sent to the application router to find and display the appropriate view for that selection.

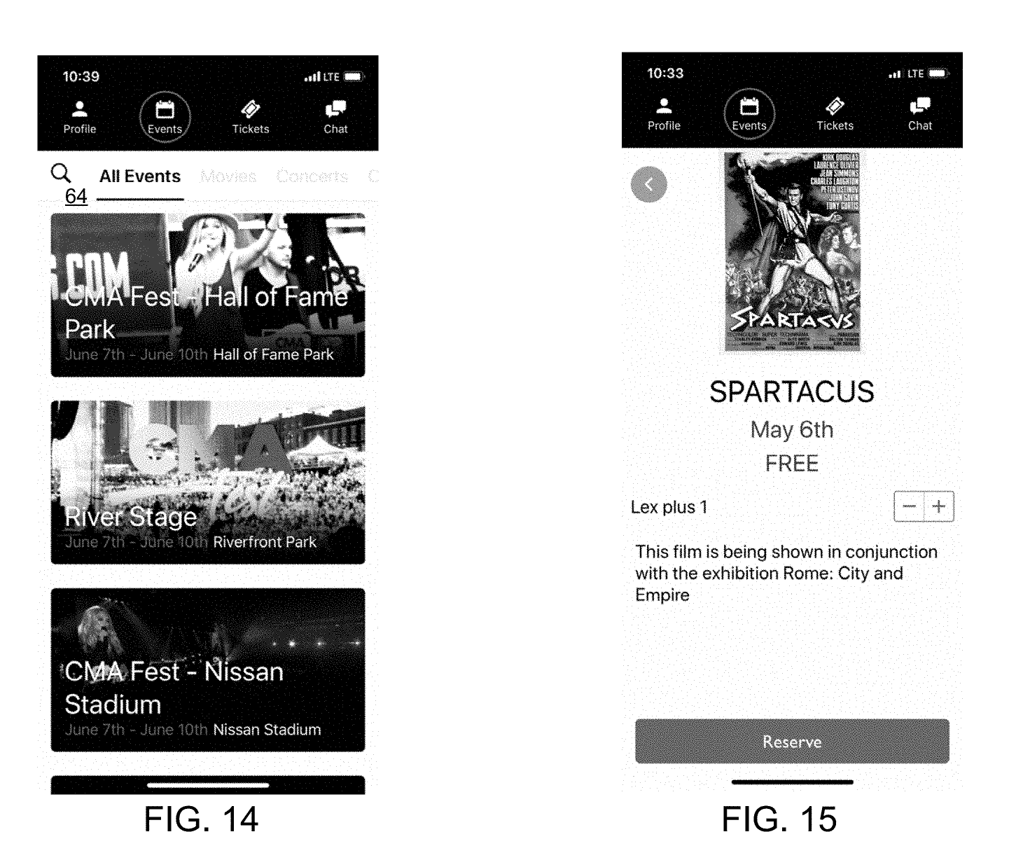

FIGS. 12 and 14 show examples of an events list view 64. Upon selection by the user (or upon entering the application, if the event list view is used as the “home” view), the application forwards a query to the system server, which retrieves and returns a list of events with associated information to the user application for rendering, filtering, and display. The list view manages all user input for reviewing and selecting an event, and in several embodiments, allows for scrolling of the entire list of events.

In the embodiment shown, the event list view uses a Fetch API to make an HTTP request to the system RESTful API, the request contains a set of encrypted data that describes the event or events the user is asking for. At a minimum, this data contains the user's current geographic area (which may be determined using the GPS capability of the user's mobile device) and the current date. Additional information or specific details include, but are not limited to, event type, genre, date, type, genre, and other locations to search. The RESTful API uses this data to perform a query against all known sources of event data to find potential event matches for this request. The response data is formatted into a JSON payload that is sent back to the client application, which caches the data locally on the user device (using standard iOS or Android data storage mechanisms). The data is then rendered, filter and displayed by the user device application.

In several embodiments, a text input box is displayed above the list view, along with a “picker” control, which allows the user to select what type of event he or she is looking for. When selected, the picker control displays a selection view that renders a pre-determined set of event types. After the user selects an event type, the event list view performs a filter function on the full data set to return a subset of data matching the type of event selected. Alternatively, the user may type one or more words into the text box to find particular events or types of events. The filter may be continuously active, so that as the user types text into the text box, the filter continues to further narrow down the data set being displayed to match the new input.

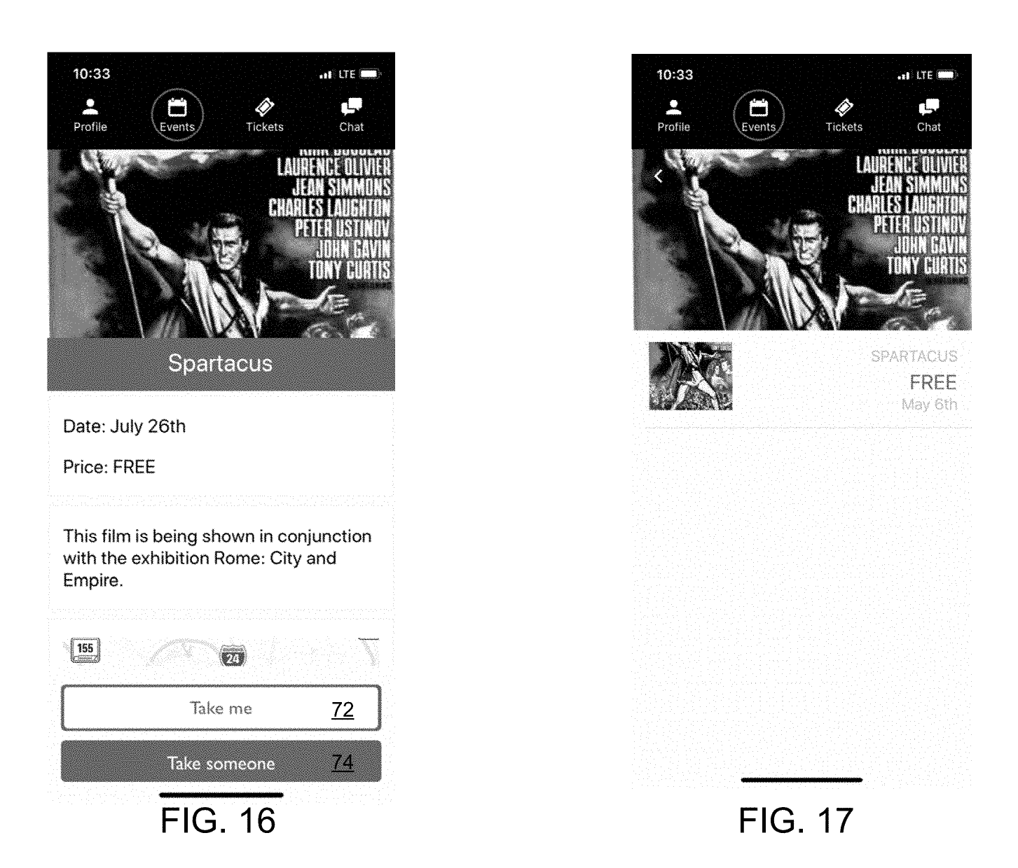

When a user selects an event from the list, the application displays the event data in the event details views, as seen in FIGS. 13, 15-17, and 25. The event details view 70 provides the detailed data for a specific event, including, but not limited to, artist or performer, event name or description, location, date(s), time(s), and price or price ranges. A map showing the location of event may also be displayed.

The event details views also allow the user to choose between (1) purchasing tickets and searching for someone to take (“Take someone” or “I want to take someone” 72), or (2) indicate that they want someone with tickets (or willing to purchase tickets) to take them to the event (“Take me” or “I want someone to take me” 74).

Users that indicate that they want someone to take them to the event are then registered and entered in the system database as potential matches for this event. This data is then subsequently used to find and determine possible matches for this user with other users who are purchasing tickets and seeking matches for the event. The user's information is sent to such other users' mobile device application for use in their “match” views, as described below. Upon selecting this option, this user is sent to the “match” view on their mobile device

Users that indicate that they want to buy tickets and then bring another user with them for an event are also registered for the event as potential matches. This data also will be used later to determine better matches. Upon selecting this option, this user is sent to the “event ticket list” view on their mobile device.

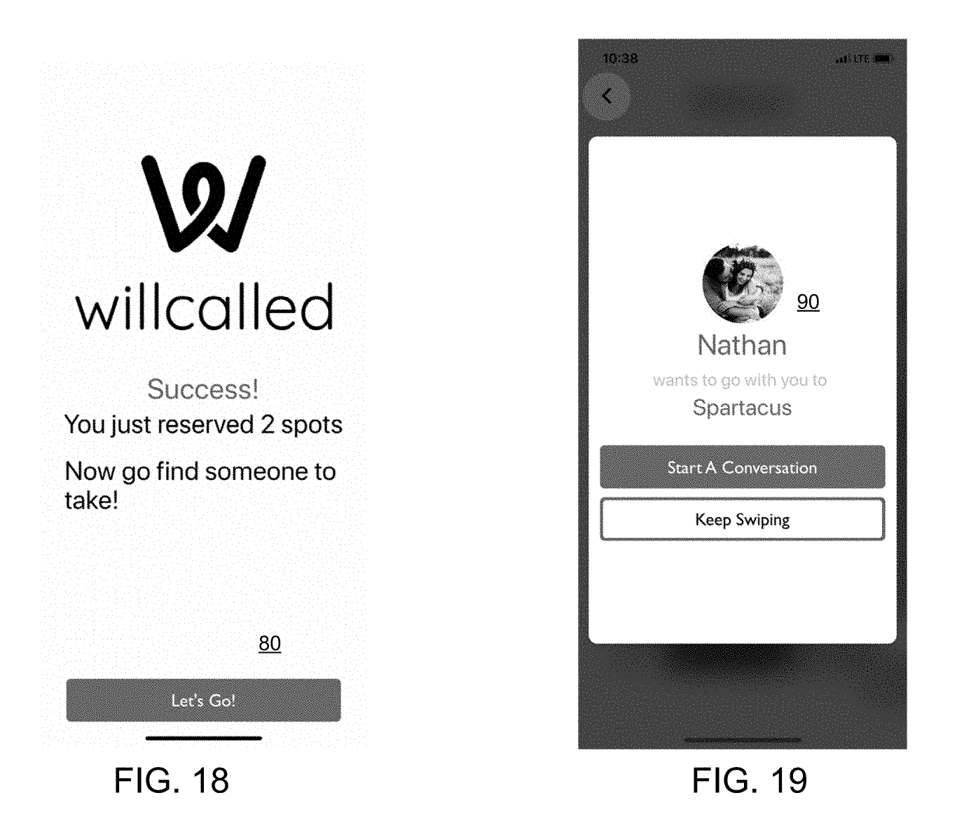

In several embodiments, an “event ticket list” view is provided, which displays the list of available tickets for the selected event. Upon selecting the desired ticket(s), the user is shown the “ticket purchase” view. The “ticket purchase” view shows the specific tickets selected, and is used for capturing the user's payment information and desired number of tickets. This data is sent to the server to handle the final payment and processing of the ticket purchase. Payments are handled either by third party payment APIs, or through a third party credit card processing service. After the purchase has been processed, the user is sent to the “match” view on their mobile device. A confirmatory screen 80 may be shown, with a prompt to seek a match to take to the event, as seen in FIG. 18.

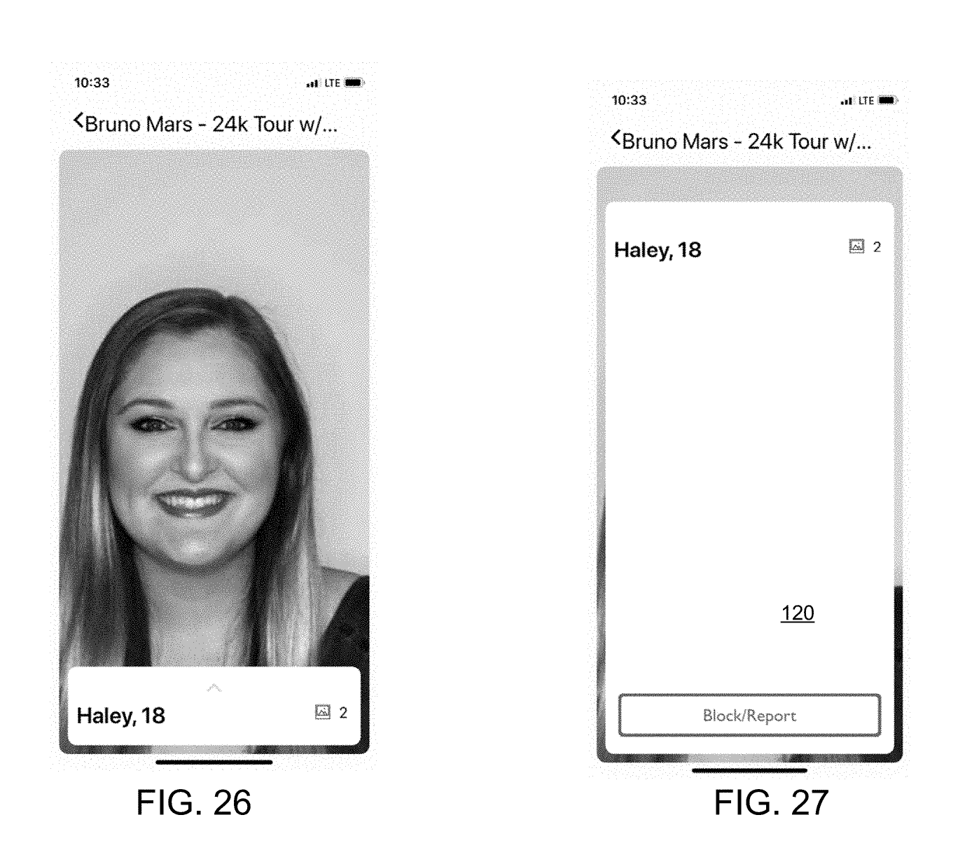

FIGS. 19 and 26 show examples of an introductory match view, which retrieves and displays potential matches 90 for the user based on various data points. The list of matches is retrieved from the server API, using a match algorithm that uses various data points such as age, gender, sexual preferences, common interests, location, and interest in common events. Once the list of potential matches has been compiled, it is formatted into a JSON payload and sent to the user's client application over HTTP.

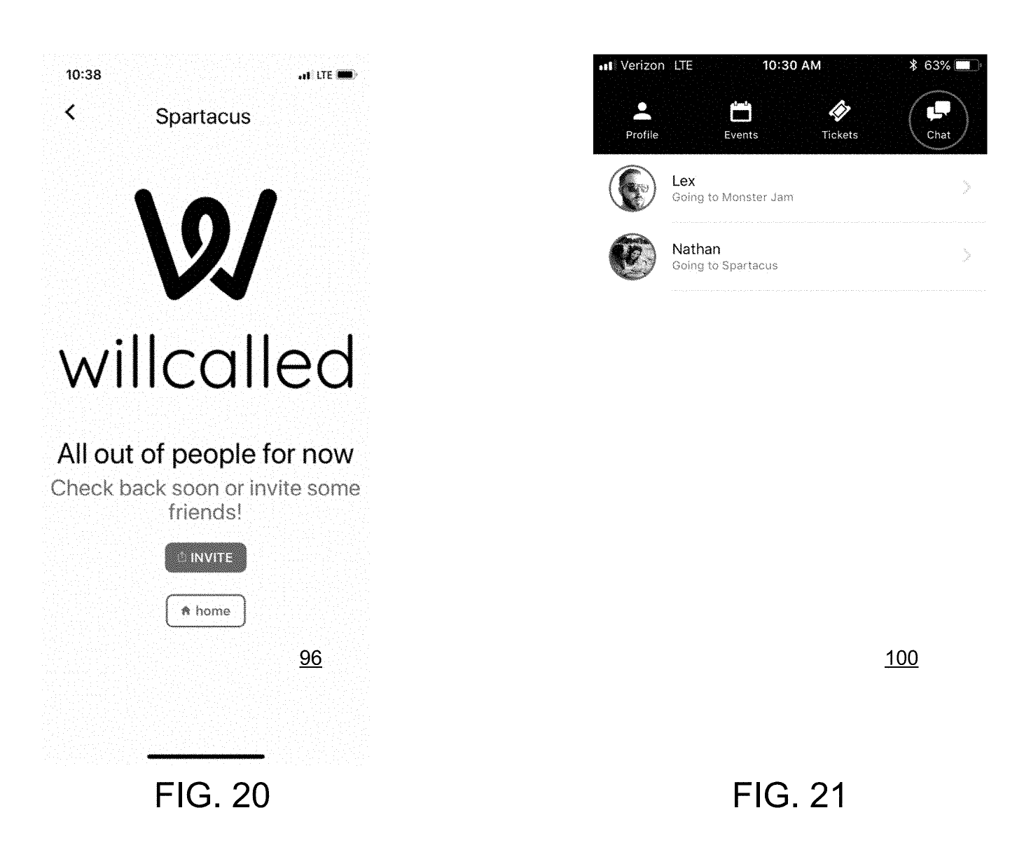

When the client application receives the JSON payload, it renders the data as a series of “cards” which, at an introductory level, include a photograph and first name (and possibly additional information, such as age, distance from the user, and short description such as a job description or title). The user can then run through the deck of “cards,” and swipe left or right to indicate disinterest or interest. For example, swiping left may show that the user is not interested in the potential match, while swiping right shows interest in the potential match. A user may also use a higher level match indicator to show a greater level of interest in the potential match. If the user continues to swipe and exhausts the list of potential matches, a screen 96 is shown alerting the user of this, as seen in FIG. 20, and prompting the user to invite some friends to the system.

If the system determines that two users have both indicated interest in each other as possible matches, then each user is offered a chance to chat 100 through the mobile device application, as seen in FIG. 19. If a user selects the option to chat, he or she is sent to the chat list view, as described below.

In one embodiment, the system includes a “My Events” view 110, which provides the user a place to see all pending events for which they have registered, both events where they have purchased tickets and are looking to take someone, and events where they are requesting to be taken. List views are used to render the data. This data is compiled and updated as the user interacts with the application and the system, and selects an option on an events page. These lists may be limited to events where a match has not been found, or may include events where a match has been found (the latter also may appear on a separate list). If a user has not yet found a match to an event, selecting the event from this view will direct them to the “match” view described above, where the user can attempt to find a match. If a match has been found, selecting the event from this view will direct them to the appropriate chat screen, wherein the user and match can converse about the event or other topics.

FIG. 21 shows an example of a chat list view 100, which shows a possible match user (which may include a small photo) and the event to which they are considering going. This data is obtained from the match data associated with the match view described above. Selecting a user in this list will open a Chat Screen view, as described below.

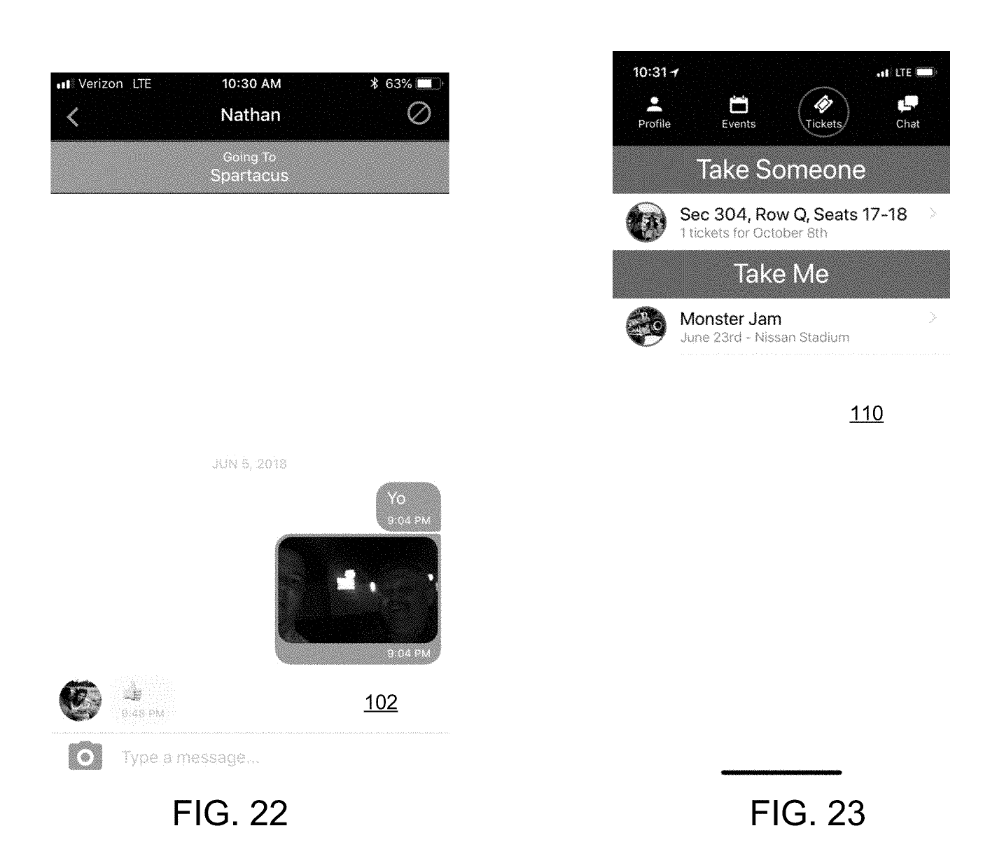

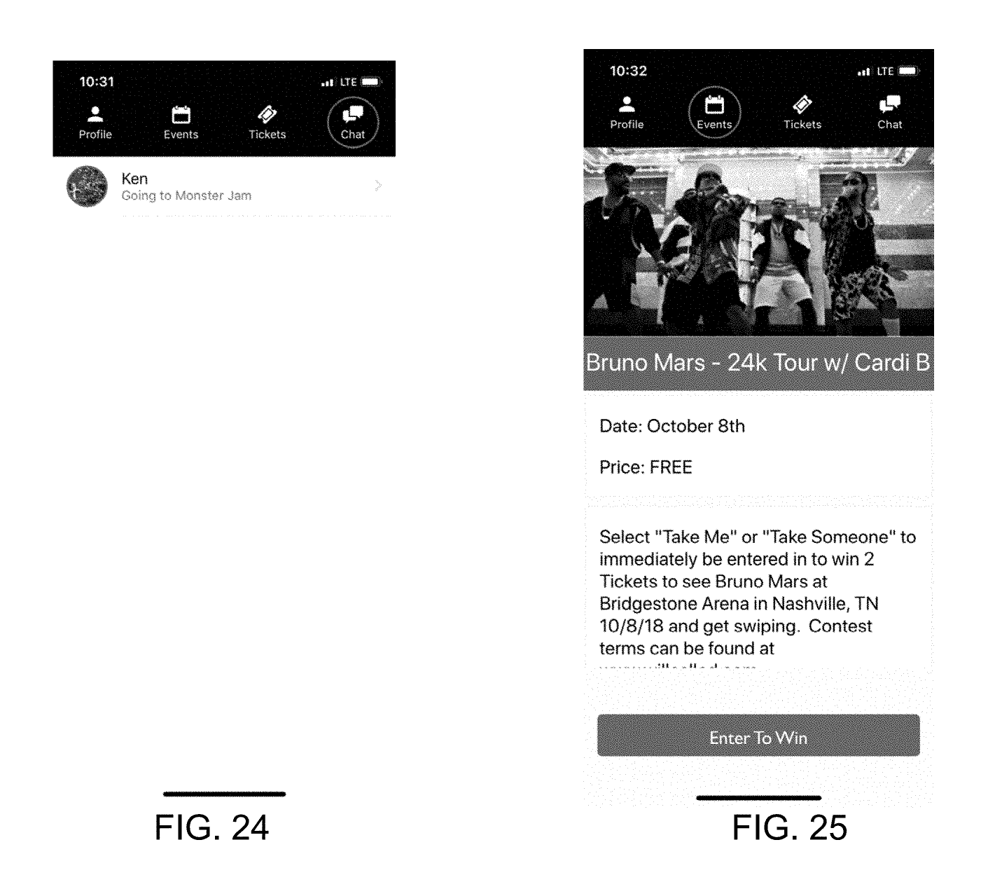

FIG. 22 shows a Chat Screen view 102, which is where conversations occur between two individuals that are discussing whether to match for an event, or that agreed to “Let's Go” with each other to an event. The chat conversation is rendered in the user application, while data for the conversation is stored on the system servers and retrieved via HTTP protocols. New messages are sent using standardized “push” notifications across both iOS and Android. As a new notification is received on a device, it contains a data payload that describes who the sender is, the ID of the chat conversation, and the message sent. This triggers to the receiving client application to open the chat view and display the conversation, which may include one or more of the most recent messages in the conversation. Older messages (which may be a predetermined number of messages back, e.g., 10 messages) may be hidden from view to conserve memory and rendering resources. Tapping “load older messages” will retrieve the next batch of messages and render them.

The chat screen view also provides a block popup 120 that offers the user a safe and secure way to exit a conversation in which he or she no longer wishes to participate, as seen in FIG. 27. The user is presented with a list of reasons for terminating the chat, and after selecting any one or more of the options, the chat is closed and the match removed from the match list. If the reason for terminating the chat indicates misuse of the platform by the other user, a flag bit is added to the offending user's profile on the system server. If a user's flag count exceeds a predetermined threshold, then the user's account is placed on hold (i.e., he or she cannot be shown as a potential match, or use the system) until a system staff member reviews the case, and determines that the user can be allowed back into the system. A user can be permanently banned in egregious cases, or where repeated reviews have been necessary.

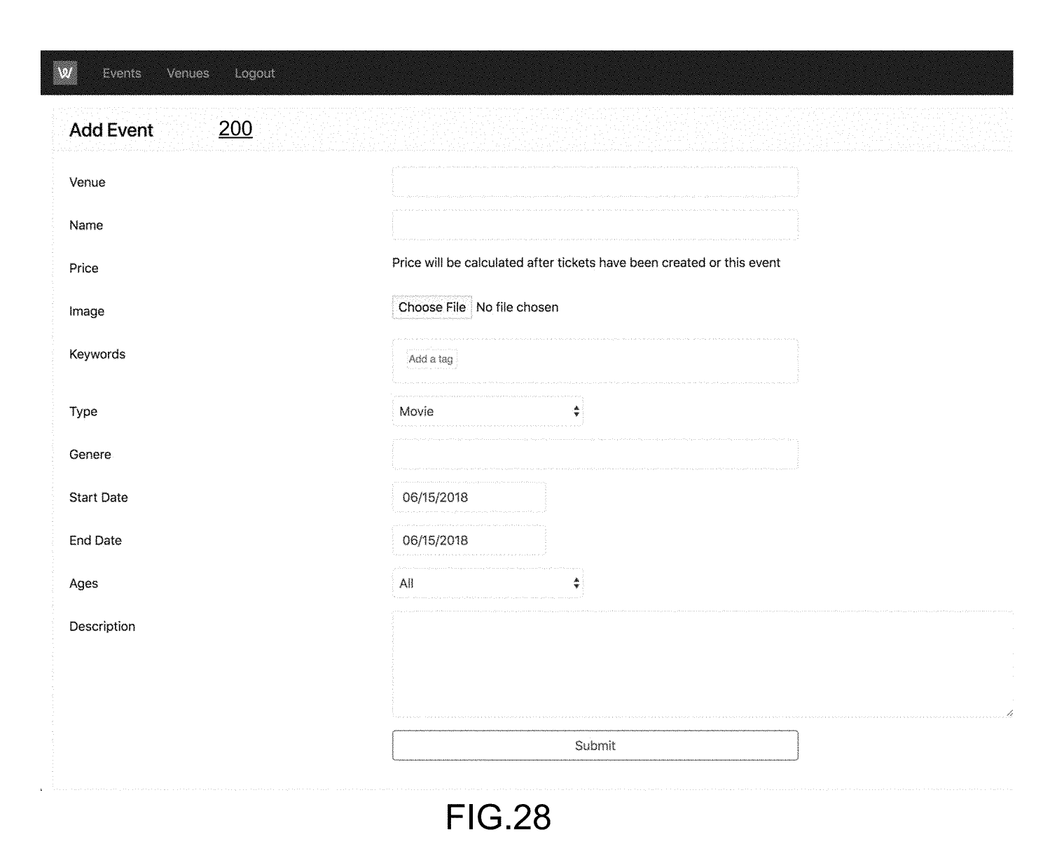

FIGS. 28-34 show examples of user interface screens from the administrative portal, which serves as a centralized user interface for managing all data needed for the mobile device applications to function. The portal allows an authorized individual to login and perform administrative tasks, including changes or modifications to underlying data used in the mobile device applications. Primary tasks include, but are not limited to, managing available events listed in the mobile device applications, and managing ticket inventor for those events (including keeping track of purchased and redeemed tickets). Ticket inventory includes free, promotional, and paid ticket types. The system allows the administrative user to add, update or delete the tickets that are available to end users of the mobile device application. End users can reserve and/or purchase tickets through the mobile device application, and all purchases are recorded in a central database. The administrative user can view all tickets purchases by one or more end users, giving the administrative user the ability to manage end users' purchases.

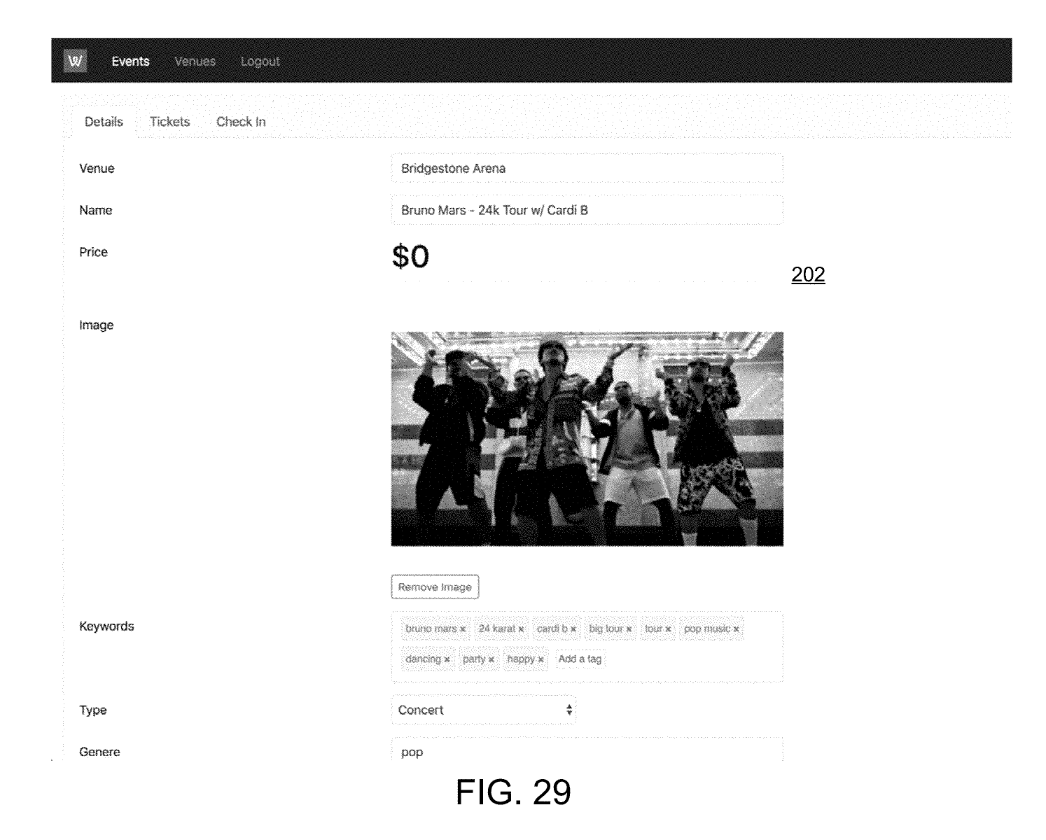

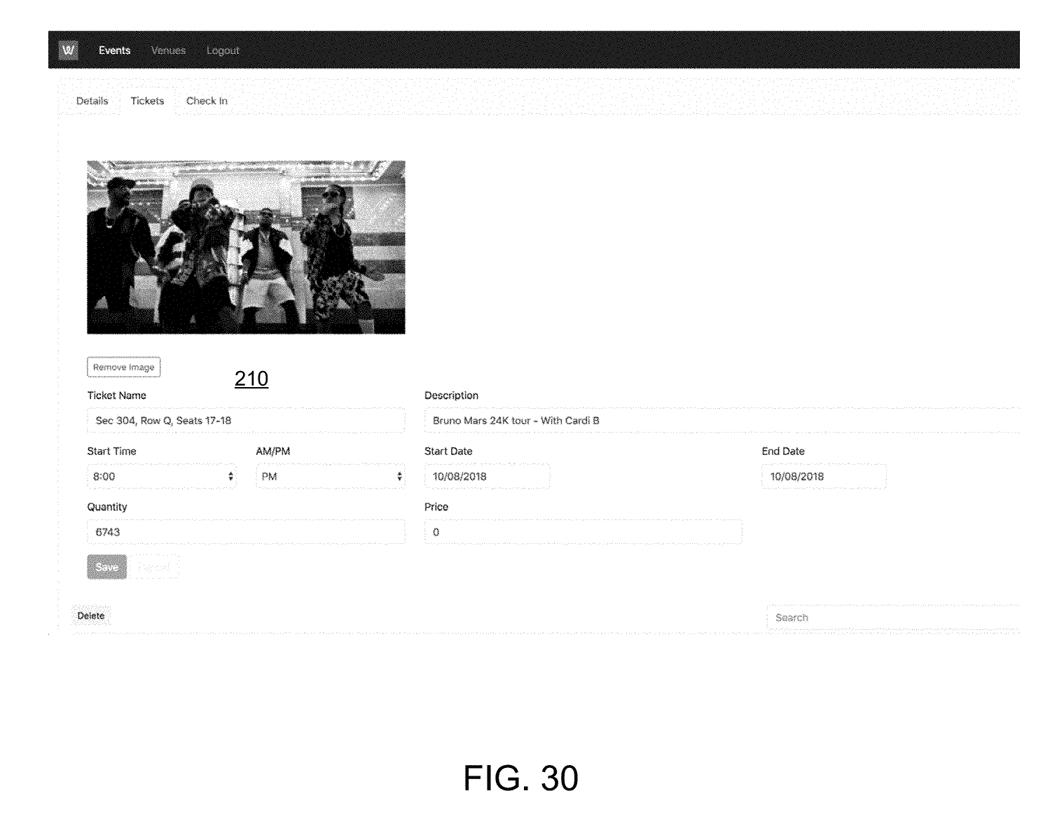

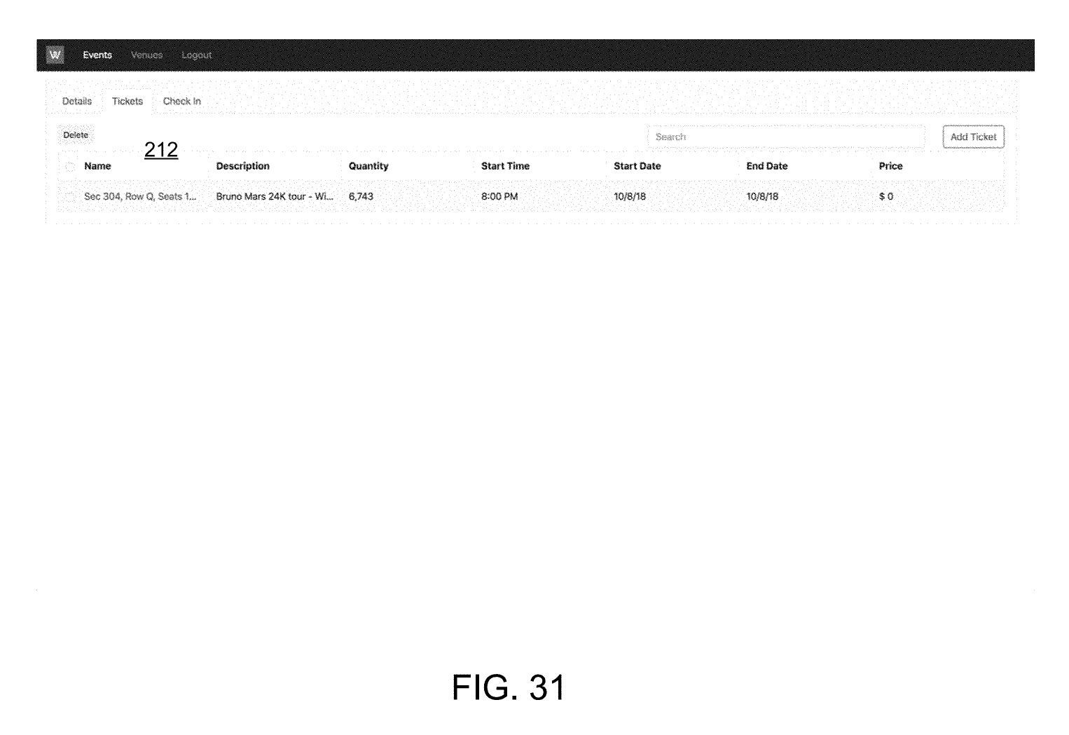

FIG. 28 shows an example of an administrative interface for adding an event 200 to the system. At this page, the administrative user can enter venue, name of the event, select an image to be displayed for the event, enter keywords that will be responsive to end user searches, the type of event (e.g., movie, concert, etc.), genre (e.g., pop, classical, etc.), start date, end date, participant age ranges, and a general description of the event. FIG. 29 shows a details screen 202 for an event that has been entered, including the event image, but where tickets have not yet been added. FIG. 30 shows the screen 210 for adding specific sets of tickets, including ticket name (e.g., section, row, seat numbers), event description or name, start time, start date, quantity and price. FIG. 31 shows the added tickets in list view 212.

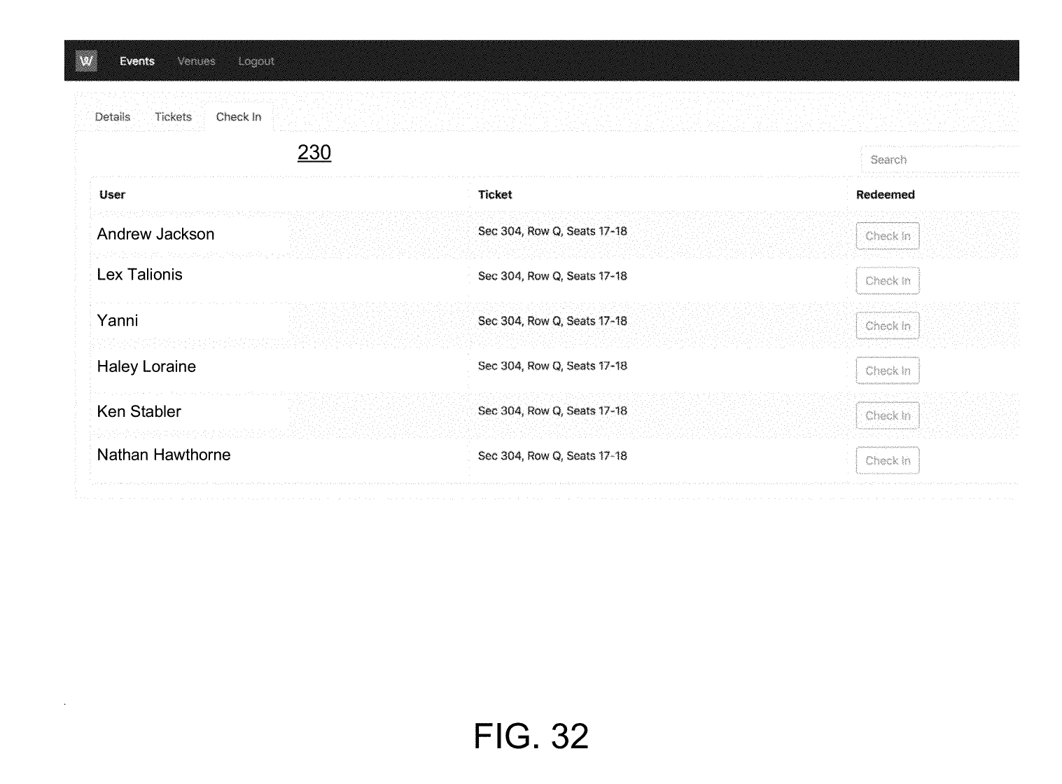

FIG. 32 shows a ticket list check-in screen 230, showing sets of tickets for an event by end user (i.e., end user who has reserved or purchased tickets). The administrative user can manage tickets for an event from this screen, including redeeming tickets for end users.

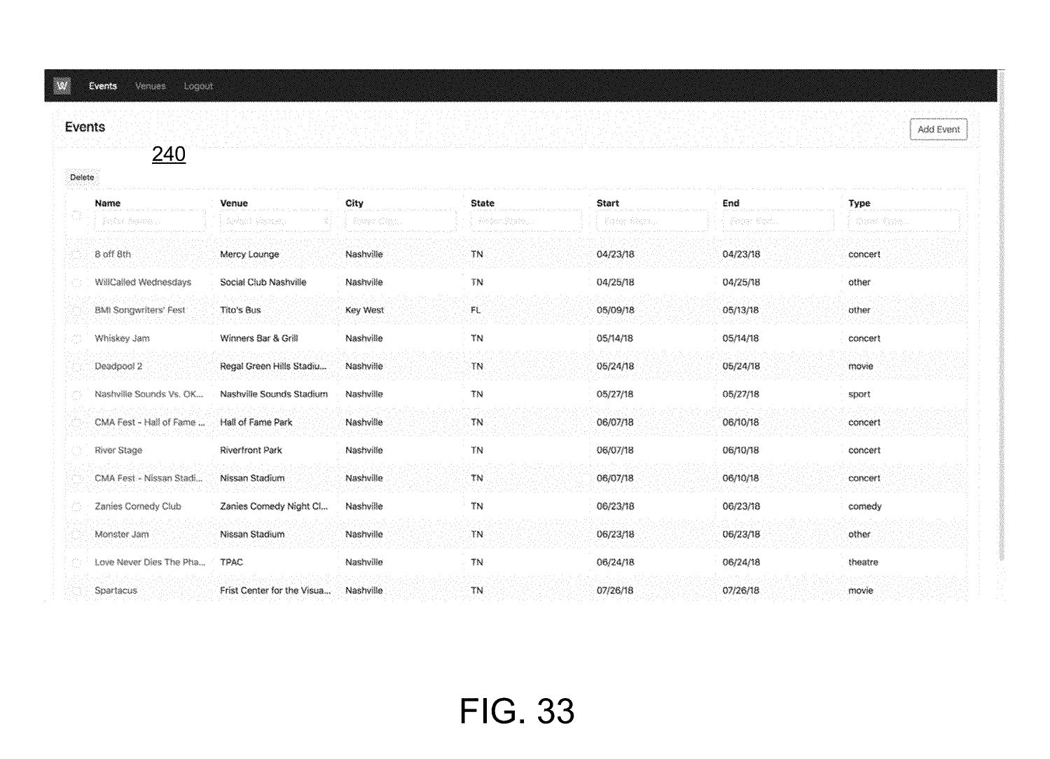

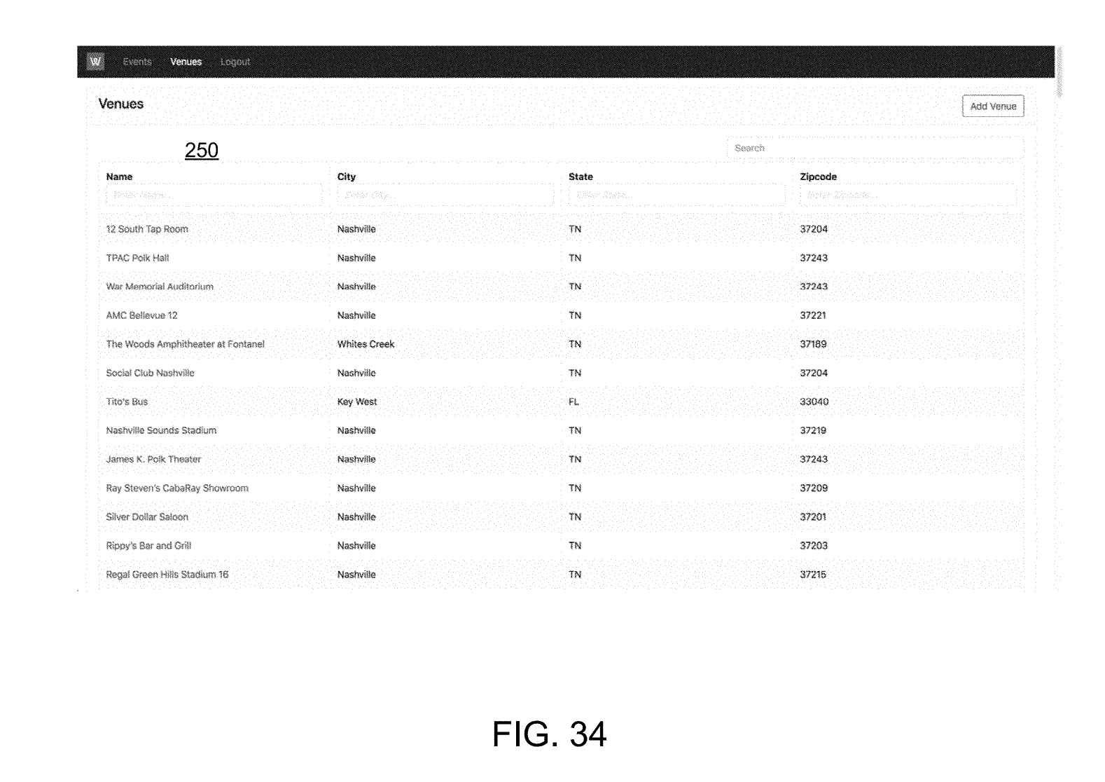

FIGS. 33 and 34 shows list views of events 240 and venues 250, including name of event, name of venue, location (city, state, zip code), start date, end dates, and type of event (e.g., movie, concert, theatre, sport, other). List views can be sorted by any selected parameter. From these screens, the administrative user can add an event, delete an event, edit information for an event, search for an event, add a venue, delete a venue, edit information for a venue, or search for a venue.

In order to provide a context for the various computer-implemented aspects of the invention, the following discussion provides a brief, general description of a suitable computing environment in which the various aspects of the present invention may be implemented. A computing system environment is one example of a suitable computing environment, but is not intended to suggest any limitation as to the scope of use or functionality of the invention. A computing environment may contain any one or combination of components discussed below, and may contain additional components, or some of the illustrated components may be absent. Various embodiments of the invention are operational with numerous general purpose or special purpose computing systems, environments or configurations. Examples of computing systems, environments, or configurations that may be suitable for use with various embodiments of the invention include, but are not limited to, personal computers, laptop computers, computer servers, computer notebooks, hand-held devices, microprocessor-based systems, multiprocessor systems, TV set-top boxes and devices, programmable consumer electronics, cell phones, personal digital assistants (PDAs), tablets, smart phones, touch screen devices, smart TV, internet enabled appliances, internet enabled security systems, internet enabled gaming systems, internet enabled watches; internet enabled cars (or transportation), network PCs, minicomputers, mainframe computers, embedded systems, virtual systems, distributed computing environments, streaming environments, volatile environments, and the like.

Embodiments of the invention may be implemented in the form of computer-executable instructions, such as program code or program modules, being executed by a computer, virtual computer, or computing device. Program code or modules may include programs, objects, components, data elements and structures, routines, subroutines, functions and the like. These are used to perform or implement particular tasks or functions. Embodiments of the invention also may be implemented in distributed computing environments. In such environments, tasks are performed by remote processing devices linked via a communications network or other data transmission medium, and data and program code or modules may be located in both local and remote computer storage media including memory storage devices such as, but not limited to, hard drives, solid state drives (SSD), flash drives, USB drives, optical drives, and internet-based storage (e.g., “cloud” storage).

In one embodiment, a computer system comprises multiple client devices in communication with one or more server devices through or over a network, although in some cases no server device is used. In various embodiments, the network may comprise the Internet, an intranet, Wide Area Network (WAN), or Local Area Network (LAN). It should be noted that many of the methods of the present invention are operable within a single computing device.

A client device may be any type of processor-based platform that is connected to a network and that interacts with one or more application programs. The client devices each comprise a computer-readable medium in the form of volatile and/or nonvolatile memory such as read only memory (ROM) and random access memory (RAM) in communication with a processor. The processor executes computer-executable program instructions stored in memory. Examples of such processors include, but are not limited to, microprocessors, ASICs, and the like.

Client devices may further comprise computer-readable media in communication with the processor, said media storing program code, modules and instructions that, when executed by the processor, cause the processor to execute the program and perform the steps described herein. Computer readable media can be any available media that can be accessed by computer or computing device and includes both volatile and nonvolatile media, and removable and non-removable media. Computer-readable media may further comprise computer storage media and communication media. Computer storage media comprises media for storage of information, such as computer readable instructions, data, data structures, or program code or modules. Examples of computer-readable media include, but are not limited to, any electronic, optical, magnetic, or other storage or transmission device, a floppy disk, hard disk drive, CD-ROM, DVD, magnetic disk, memory chip, ROM, RAM, EEPROM, flash memory or other memory technology, an ASIC, a configured processor, CDROM, DVD or other optical disk storage, magnetic cassettes, magnetic tape, magnetic disk storage or other magnetic storage devices, or any other medium from which a computer processor can read instructions or that can store desired information. Communication media comprises media that may transmit or carry instructions to a computer, including, but not limited to, a router, private or public network, wired network, direct wired connection, wireless network, other wireless media (such as acoustic, RF, infrared, or the like) or other transmission device or channel This may include computer readable instructions, data structures, program modules or other data in a modulated data signal such as a carrier wave or other transport mechanism. Said transmission may be wired, wireless, or both. Combinations of any of the above should also be included within the scope of computer readable media. The instructions may comprise code from any computer-programming language, including, for example, C, C++, C#, Visual Basic, Java, and the like.

Components of a general purpose client or computing device may further include a system bus that connects various system components, including the memory and processor. A system bus may be any of several types of bus structures, including, but not limited to, a memory bus or memory controller, a peripheral bus, and a local bus using any of a variety of bus architectures. Such architectures include, but are not limited to, Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computing and client devices also may include a basic input/output system (BIOS), which contains the basic routines that help to transfer information between elements within a computer, such as during start-up. BIOS typically is stored in ROM. In contrast, RAM typically contains data or program code or modules that are accessible to or presently being operated on by processor, such as, but not limited to, the operating system, application program, and data.

Client devices also may comprise a variety of other internal or external components, such as a monitor or display, a keyboard, a mouse, a trackball, a pointing device, touch pad, microphone, joystick, satellite dish, scanner, a disk drive, a CD-ROM or DVD drive, or other input or output devices. These and other devices are typically connected to the processor through a user input interface coupled to the system bus, but may be connected by other interface and bus structures, such as a parallel port, serial port, game port or a universal serial bus (USB). A monitor or other type of display device is typically connected to the system bus via a video interface. In addition to the monitor, client devices may also include other peripheral output devices such as speakers and printer, which may be connected through an output peripheral interface.

Client devices may operate on any operating system capable of supporting an application of the type disclosed herein. Client devices also may support a browser or browser-enabled application. Examples of client devices include, but are not limited to, personal computers, laptop computers, personal digital assistants, computer notebooks, hand-held devices, cellular phones, mobile phones, smart phones, pagers, digital tablets, Internet appliances, and other processor-based devices. Users may communicate with each other, and with other systems, networks, and devices, over the network through the respective client devices.

Thus, it should be understood that the embodiments and examples described herein have been chosen and described in order to best illustrate the principles of the invention and its practical applications to thereby enable one of ordinary skill in the art to best utilize the invention in various embodiments and with various modifications as are suited for particular uses contemplated. Even though specific embodiments of this invention have been described, they are not to be taken as exhaustive. There are several variations that will be apparent to those skilled in the art.

What is claimed is:

1. A system for identifying and obtaining access to events, comprising:
a computer server with a node server application in electronic communication with a database, said node server application configured to electronically communicate with a plurality of user applications operating on a plurality of user mobile devices, and one or more event ticketing applications;
wherein the node server application is further configured to:
receive, from a first user through a first user application on a first user mobile device, a request by the first user to purchase tickets to an event;
obtain tickets to said the event for the first user;
provide to the first user a list of users seeking to attend the event;
receive, from the first user, an request to initiate an electronic communication exchange with a second user from the list of users seeking to attend the event; and
initiate the electronic communication exchange between the first and second user.

2. The system of claim 1, wherein the list of users seeking to attend the event comprises a plurality of digital cards, each card comprising a photograph and first name for a particular user.

3. A system for identifying and obtaining access to events, comprising:
a computer server with a node server application in electronic communication with a database, said node server application configured to electronically communicate with a plurality of user applications operating on a plurality of user mobile devices, and one or more event ticketing applications;
wherein the node server application is further configured to:
receive, from a first user through a first user application on a first user mobile device, a request by the first user to attend the event;
provide to the first user a list of users in possession of tickets to the event and seeking another user to take to the event;
receive, from the first user, an request to initiate an electronic communication exchange with a second user from the list of users in possession of tickets to the event and seeking another user to take to the event; and
initiate the electronic communication exchange between the first and second user.

4. The system of claim 3, wherein the list of users in possession of tickets to the event and seeking another user to take to the event comprises a plurality of digital cards, each card comprising a photograph and first name for a particular user.
